(19) United States
(12) Patent Application Publication
(10) Pub. No.: US 2013/0263482 A1
(43) Pub. Date: Oct. 10, 2013

(54) CABLE IDENTIFICATION APPARATUS, KIT AND METHOD

(71) Applicant: Erin STRATER, Los Angeles, CA (US)

(72) Inventor: Erin STRATER, Los Angeles, CA (US)

(21) Appl. No.: 13/439,552

(22) Filed: Apr. 4, 2012

(51) Int. Cl. G09F 3/00

(52) U.S. Cl. 40/316

(57) ABSTRACT

An identifier for an electronic device cable, kit and method for use thereof is provided. The identifier has a lid and base that clamp together around an electronic device cable to allow the cable to be easily identified.

### BACKGROUND OF THE INVENTION

1. Technical Field

The present invention relates to an apparatus, kit and method for identifying cables.

2. Description of Related Art

Electronic devices which are commercially available include laptop computers, cellular telephones, music players, and GPS navigation systems. Such electronic devices are typically powered by at least one rechargeable internal battery, which must be periodically recharged from an external power source. Most commonly, these rechargeable devices include a charging cable that facilitates the transfer of power from a power source into the device.

Some electronics battery chargers have a charging cable that cannot be easily disconnected from the charger and electrical circuitry, while others have a charging cable connected by a plug and jack or other similar connection which can be easily connected and disconnected by the user. The end of the cable opposite the charger is capable of being electrically connected to the electronic device using a plug and jack or other similar electrical connection to facilitate the transfer of power from a wall outlet, through the charging cable, to the internal battery of the mobile electronic device.

Electronic devices can also use other types of cables to enable certain other functions. For example, many mobile telephones and music players include a set of headphones that connects to the device and allows a user to make telephone calls or listen to music. The headphones can typically be disconnected from the device when not in use. Also, most audio-visual equipment used in the home, such as televisions, stereos, speakers, and supporting equipment use wires or cables to route power and communication signals.

### SUMMARY OF THE INVENTION

The present invention is directed to an apparatus, method and kit for identifying cables used with electronic devices. In one embodiment, the apparatus is an identifier that attaches to a cable, comprising a base with a channel configured to receive the cable, and a lid that removably attaches to the base. In another embodiment, the base further comprises at least one of an attaching member and a socket, and wherein the lid further comprises at least one of an attaching member and a socket which is complimentary to the attaching member or the socket of the base. In another embodiment, the lid comprises at least one attaching member and wherein the base comprises at least one socket configured to receive at least one attaching member. In still another embodiment, at least one attaching member comprises a ridge configured to mate with a rim of at least one socket, thereby removably attaching the lid to the base.

In another embodiment, the lid further comprises a viewing window. In still another embodiment, the identifier further comprises an identifying insert configured to fit between the lid and the base. In another embodiment, the lid further comprises a recess configured to receive the identifying insert. In one embodiment, the identifier comprises a horizontal cross section of oval shape.

In one embodiment, the lid and base are configured to completely separate when the lid and base are not mated. In another embodiment, the lid and base are connected by a hinge.

In one embodiment the channel comprises a width and a length, wherein said width is substantially constant throughout said length. In another embodiment, the base comprises a base length and a base width, wherein the base length is greater than the base width, and wherein the channel is a lengthwise axial channel.

The identifier may further comprise at least two apertures, with an aperture located at each end of the channel, wherein each aperture is defined by the channel and the lid. In another embodiment, the identifier further comprises an outer surface having substantially no corners or sharp edges when said lid is attached to said base.

Another embodiment of the invention is a kit comprising at least two identifiers of the present invention, wherein said at least two identifiers comprise substantially the same outer dimensions, and wherein the channel of each base comprises a width which is different from at least one other base. In another embodiment, the lids and bases of each identifier comprise attaching members or sockets of different size or shape, such that each specific lid for each specific identifier will only attach to a base that corresponds to that specific lid and no others. Still another embodiment of the invention is a method of identifying a cable comprising attaching the identifier of claim 1 to said cable.

The invention surprisingly overcomes several problems that have not been solved in the prior art, including the long felt need for a way to protect a mobile electronic device while it is charging by an AC charger. The solution disclosed and claimed herein provides superior performance to devices known in the art, but at extremely lower cost than devices known in the art.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of one embodiment of the present invention with the lid attached to the base.

FIG. 2 is an exploded view of one embodiment of the present invention.

FIG. 3 is a front elevation view of one embodiment of the present invention in use, with a zoom window.

### DETAILED DESCRIPTION

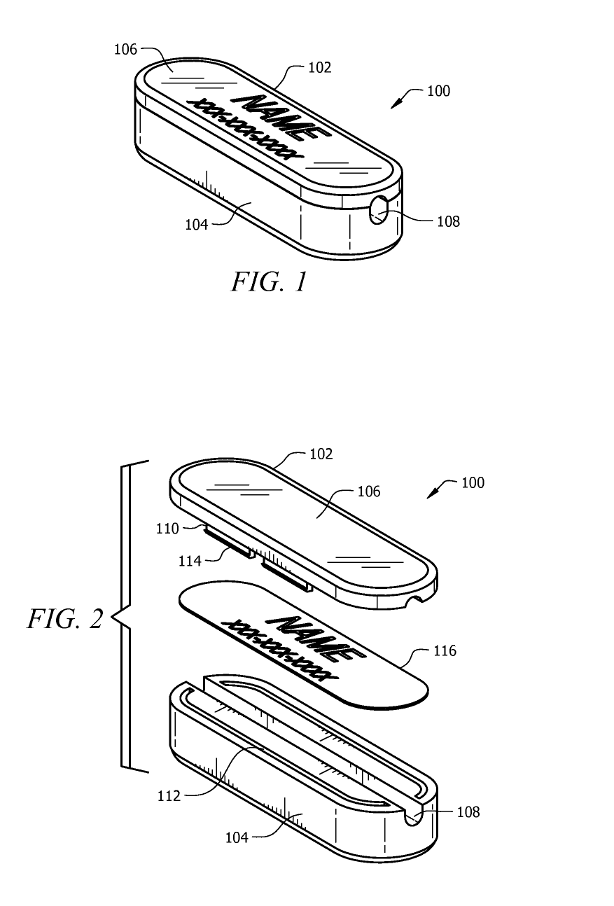

The present invention relates to an identifier for cables used with electronic devices. One embodiment of the identifier is depicted in FIGS. 1 and 2. In FIG. 1, the identifier 100 is depicted as comprising a base 104 and a lid 102. FIG. 2 depicts one embodiment of the identifier 100 with the base 104 and lid 102 separated. The base 104 comprises a channel or groove 108 configured to receive an electronic device cable, and a socket 112 configured to receive and mate with an attaching member 110 protruding from the lid 102. The lid 102 comprises at least one attaching member 110 configured to place or fit within the socket 112 (mate with the socket 112), and removably attach the lid 102 to the base 104.

A lid can be said to removably attach to a base when the lid remains attached to the lid when the attaching member has mated with the socket, yet can be detached from the lid when outward or separating force is applied between the lid 102 and base 104. One method of applying an outward or separating force is to slide a relatively rigid wedge between the lid and base, such as a human fingernail or a thin piece of plastic or metal. In other words, the attaching member and socket provide a clamping force that retains the lid on the socket until sufficient separating force is applied. In the embodiment depicted in FIG. 2, the attaching member comprises a ridge 114, and the socket 112 comprises an inner lip that the ridge slides past as the lid is mated with the base. When the lid is adjacent to the base, the ridge has slid beyond the inner lip of the socket, mates with the lip, and provides the clamping force described above. In practice, the experience of the user is that the lid snaps into place when it is attached to the base.

In a preferred embodiment, depicted in FIGS. 1 and 2, the identifier 100 comprises a base length and a base width, wherein the base length is greater than the base width, and wherein the channel 108 is a lengthwise axial channel. As depicted in FIG. 2, when the lid 102 is attached to the base, the identifier comprises an aperture on each end. In one embodiment, each aperture is defined by the channel 108 and the lid 102.

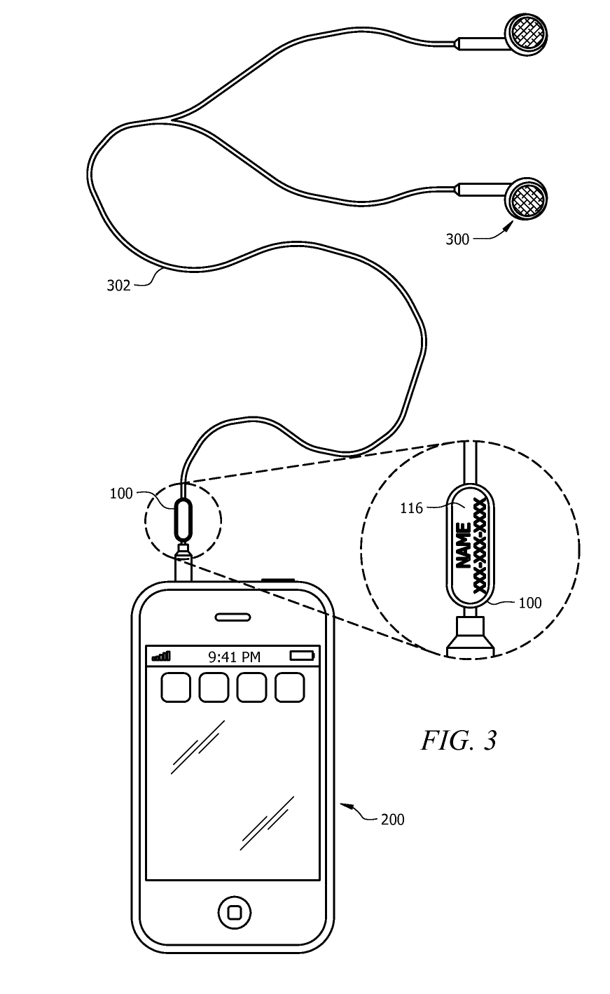

FIG. 3 depicts one embodiment of the identifier 100 in use. Therein is depicted a mobile telephone 200 with a set of headphones 300 plugged into the headphone jack. The cable identifier 100 is attached to the headphone cable 302 near the end of the cable that plugs into the headphone jack. However, the structure of the identifier 100 allows it to be placed anywhere along the length of the headphone cable 302. When in use, portions of the electronic device cable being identified will protrude from each aperture, as depicted in the zoom window of FIG. 3.

The embodiment depicted in FIGS. 1-3 also comprises a lid 102 with a viewing window 106. The viewing window can be any transparent or translucent material. In a preferred embodiment, the entire lid 102 is made of a transparent or translucent material. As depicted in FIG. 3, when a viewing window 106 is present, a user of the present invention can utilize an identifying insert that is viewable through the viewing window 106. An identifying insert can be made of virtually any relatively solid material that can retain identifying marks. In a preferred embodiment, the identifying marks will allow the owner of the electronic device cable to be easily ascertained. For example, a user may print his or her name, telephone number or email address on a small piece of paper that is in a shape complimentary to the inside of the lid 102. However, the identifying insert could be made of plastic, metal, or any other solid material capable of retaining identifying marks and being placed inside the lid 102 before it is attached to the base 104. In one embodiment, the inside of the lid 102 comprises a recess (not shown) configured to receive an identifying insert.

FIG. 1 through 3 depict one embodiment of the present invention, other adaptations, modifications and changes to form and detail can be employed without departing from the spirit and scope of the invention in its broadest respects. The essential features of the electronic cable identifier of the present invention are a base comprising a channel configured to receive an electronic device cable and a lid configured to removably attach to the base. When the lid is attached to the base, the identifier comprises two apertures at opposite ends of the channel. Different embodiments of the identifier can comprise one or a combination of the features described below.

In a preferred embodiment, the channel in the base comprises a cross-section which is at least partially rounded and a substantially constant width throughout its length. In other embodiments, the channel has a V-shaped, open square, open rectangular or other geometric cross-section capable of receiving an electronic device cable. In still other embodiments, the width of the channel is not substantially constant throughout its length.

A substantially constant channel width is preferred when an identifier is intended to be used with a specific cable of known diameter. In this circumstance, the channel can be configured to fully surround the cable when the identifier is attached to the cable, providing the maximum amount of friction possible to retain the identifier in place where it is attached to the cable, because the maximum amount of surface area possible is in contact with the cable. If the channel is wider in the middle than it is at the apertures, the identifier may be more prone to slip up and down the cable when in use, but may also be capable of attaching to cables of different widths.

In a preferred embodiment, the at least one attaching member is located on the lid and the at least one complimentary socket is located on the base. A complimentary socket is one configured to receive a corresponding attaching member. In other embodiments, the base comprises at least one attaching member and the lid comprises at least one complimentary socket. In still another embodiment, both the base and the lid comprises one or more attaching members or one or more complimentary sockets.

In a preferred embodiment, the attaching member is a fin or rib, and the socket is a complimentary slot configured to receive the fin or rib. In other embodiments, the attaching member comprises a rod and the socket comprises a hole, or other suitable male/female connection means. In another embodiment, the attaching member is a clasp.

In a preferred embodiment, the clamping force that holds the lid and the base together is provided by a ridge on the attaching member that mates with a rim on the socket. In another embodiment, the attaching member is inwardly or outwardly biased when the lid is separate from the base, and the bias provides the clamping force to hold the lid and base together. In still another embodiment, the materials used to make the attaching member and/or socket can comprise a coefficient of friction between them that resists the separation of the lid from the base. Other means of removably attaching the lid to the base can also be used. In another embodiment, a glue or adhesive can be used to permanently attach the lid to the base.

In a preferred embodiment, the lid and base are two pieces capable of completely separating such that they are not touching when the identifier is removed from a cable. In another embodiment, the lid and base are adjoined on one side by a hinge, so that the lid and base rotate away from one another when the identifier is removed from a cable.

In a preferred embodiment, the horizontal cross sectional shape of the identifier 100 is an oblong oval. In other embodiments, the horizontal cross section is any other geometric shape, such as a square, rectangle, oval or circle. Geometric shapes with rounded edges are preferred because sharp edges may cause discomfort or harm to the user, or may catch on clothing or other obstructions, when the identifier is in use. In a preferred embodiment, the identifier comprises an external surface that is substantially smooth, or with substantially no sharp edges or corners.

In a preferred embodiment, the identifier is made of a wide range of synthetic or semi-synthetic organic or inorganic polymers that can be molded or otherwise conformed into desired shapes and structures. In a most preferred embodiment, the lid and base are manufactured by injection molding of a polymer resin. Examples of polymers that can be used to produce the lid and base include, without limitation, one or a combination of polyethylene, polypropylene, polystyrene, polycarbonate, polyvinyl chloride, acrylonitrile butadiene styrene copolymer (ABS), and polytetrafluoroethylene (PTFE). Bio-based, compostable, or bio-degradable polymers may also be used as a part of one or both of the lid and the base, examples of which include polylactic acid (PLA), polyhydroxyalkanoate (PHA), and polyhydroxybutyrate (PHB).

Another embodiment of the present invention is a kit comprising at least two identifiers of the present invention. In a preferred embodiment, the identifiers are configured to fit two different electronic device cables. For example, according to one embodiment, the kit comprises an identifier for a mobile telephone charging cable and another identifier for a headphone cable. Typically, a mobile telephone charging cable has a larger diameter than a headphone cable. In this example, one identifier in the kit can be configured with a channel having a larger width, and consequently, larger apertures, than the width of the channel in the other identifier.

In a preferred embodiment, all of the identifiers in the kit have substantially the same outer dimensions and shape, but each identifier has a channel of unique size configured to receive a specific cable, as in the example of the headphone cable and charging cable described above. The preference for substantially equivalent size and shape of the identifiers is more than an aesthetic preference; the identifiers of the present invention are sized such that they are small enough to be unobtrusive when in use, but large enough that any identifying marks on them can be easily discerned by human eyes.

In another embodiment, all of the identifiers have substantially the same outer dimensions and shape, but the lids and bases of the respective identifiers comprise attaching members and sockets, as appropriate, having different sizes and/or shapes, such that a lid of one identifier will not attach or mate with the base of a different identifier. In this embodiment, the lids, and any accompanying identifying inserts, can be consistently used with its corresponding base. Mixing different lids and bases could present problems when a kit comprises identifiers with channels of unique size. Because the lid defines a portion of each aperture, a lid configured to define a small aperture may not mate with a base configured to define a larger aperture to provide an identifier with optimum functionality. When both the lid and base are configured to provide an aperture sized for a specific cable, the device will function best when the same lid and base are used consistently with each other. Consequently, in one embodiment, the kit comprises at least two identifiers, wherein the lids and bases of each identifier comprise attaching members or sockets of different size or shape, such that a lid for a specific identifier will only attach to its corresponding base and no others.

In one embodiment, the kit includes at least one identifier of the present invention and at least one identifying insert. The identifying insert can be made of any generally solid material, and comprises a size and shape such that it will fit between the viewing window of the lid and the base when the lid is attached to the base. The identifying insert comprises identifying marks, which may be one or a combination of alphanumeric characters, drawings, paintings, photos or colors. In a preferred embodiment, the identifying marks comprise contact information for the owner of the cable the identifier will be attached to.

The method of the present invention is a method of identifying a cable comprising the step of attaching an identifier of the present invention to the cable.

The present invention is an improvement in the art in several important ways. Previously, when an electronic device owner wanted to identify or mark the cables associated with their devices, they would resort to inelegant solutions such as “twist ties” (pieces of wire wrapped in colored paper or plastic), paper clips, or printed label strips with adhesive backing Repurposing twist ties and paper clips into cable identifying devices is inferior to the present invention because twist ties and paper clips are not customizable, may not attach to the cables securely, and are not streamlined to prevent them from catching on clothing and other obstacles when in use. Similarly, while a printed label strip with an adhesive backing is customizable, it is also inferior because the paper label is subject to damage during normal use, and may leave adhesive behind on the cable when it is removed. The identifier of the present invention, by stark contrast, is an elegant solution to the problem of identifying electronic device cables. It is durable, highly customizable, attaches securely to the cable, will not catch on clothing, and can removably attach to a cable without leaving any permanent trace.

It will now be evident to those skilled in the art that there has been described herein an identifier that removably attaches to a cable used with an electronic device. Although the invention hereof has been described by way of preferred embodiments, it will be evident that other adaptations and modifications can be employed without departing from the spirit and scope thereof The terms and expressions employed herein have been used as terms of description and not of limitation; and thus, there is no intent of excluding equivalents, but on the contrary it is intended to cover any and all equivalents that may be employed without departing from the spirit and scope of the invention.

In sum, while this invention has been particularly shown and described with reference to a preferred embodiment, it will be understood by those skilled in the art that various changes, in form and detail may be made therein without departing from the spirit and scope of the invention.

We claim:

1. An identifier comprising:
a base comprising a channel configured to receive a cable;
a lid configured to removably attach to said base;
wherein said lid and said base are configured to completely separate when said lid and said base are not mated;
wherein said base further comprises at least one of an attaching member and a socket, and wherein said lid further comprises at least one of an attaching member and a socket which is complimentary to said attaching member or said socket of said base;
wherein said channel comprises a width and a length, wherein said width is substantially constant throughout said length; and
wherein said identifier further comprises an outer surface having substantially no corners or sharp edges when said lid is attached to said base.

2. (canceled)

3. The identifier of claim 1 wherein said lid comprises at least one attaching member and wherein said base comprises at least one socket configured to receive said at least one attaching member.

4. The identifier of claim 3 wherein at least one said attaching member comprises a ridge configured to mate with a rim of at least one said socket, thereby removably attaching said lid to said base.

5. The identifier of claim 1 wherein said lid further comprises a viewing window.

6. The identifier of claim 5 further comprising an identifying insert configured to fit between said lid and said base.

7. The identifier of claim 6 wherein said lid further comprises a recess configured to receive said identifying insert.

8. The identifier of claim 1 further comprising a horizontal cross section of oval shape.

9. (canceled)

10. (canceled)

11. (canceled)

12. The identifier of claim 1 wherein said base comprises a base length and a base width, wherein said base length is greater than said base width, and wherein said channel is a lengthwise axial channel.

13. The identifier of claim 1 further comprising at least two apertures, with an aperture located at each end of said channel, wherein each aperture is defined by said channel and said lid.

14. (canceled)

15. A kit comprising at least two identifiers of claim 1, wherein said at least two identifiers comprise substantially the same outer dimensions, and wherein said channel of each said base comprises a width which is different from at least one other said base.

16. The kit of claim 15 wherein said lids and said bases of each identifier comprise attaching members or sockets of different size or shape, such that each specific lid for each specific identifier will only attach to a base that corresponds to that specific lid and no others.

17. A method of identifying a cable comprising attaching the identifier of claim 1 to said cable.
